(19) United States
(12) Patent Application Publication
(10) Pub. No.: US 2010/0203471 A1
(43) Pub. Date: Aug. 12, 2010

(54) DENTAL FILLING MATERIAL

(75) Inventor: Ho-Jin BAE, Seoul (KR)

Correspondence Address: RABIN & Berdo, PC, 1101 14TH STREET, NW, SUITE 500, WASHINGTON, DC, 20005, US

(73) Assignee: SureDent Corporation, Gyeonggi-Do (KR)

(21) Appl. No.: 12/701,179

(22) Filed: Feb. 5, 2010

(30) Foreign Application Priority Data
Feb. 6, 2009 (KR) 10-2009-0009923

(51) Int. Cl. A61C 5/02

(52) U.S. Cl. 433/102

(57) ABSTRACT

A dental filling material includes a head; a distal tip opposite the head, wherein the distal tip is designed to be first inserted into a tooth root canal, a body tapered from the head to the distal tip, with a diameter decreasing from the head to the distal tip, one or more work length marks formed on the body. The work length marks indicate a work length. One or more taper marks are formed on the head in order to indicate a degree of taper. The work length marks are formed on a portion of the body, the portion of the body extending to the distal tip with a predetermined interval from the taper marks. Both the taper marks and the work length marks have the same color, which corresponds to a value of the diameter, in order to identify the diameter.

### BACKGROUND OF THE INVENTION

(a) Field of the Invention

The present invention relates to dental filling materials, and more particularly, to dental filling materials that have improved structures such that sizes and work lengths thereof are marked thereon.

(b) Description of the Related Art

A dental root canal filling material (hereinafter, referred to as ‘dental filling material’) is a material for dental practice that is used to hermetically fill a common neural tube or dental root canal of a tooth after the nerve and capillary vessels of the tooth have been removed due to the decay of the dental pulp of the tooth.

A filling procedure using such a dental filling material is fundamental to clinical treatment. If the filling of the root canal is not properly carried out, a cavity forms inside the root canal, thereby damaging periodontal tissues around the root tip. If the periodontal tissues are severely damaged, the tooth must be extracted. Accordingly, the filling of the root canal is critical to the success of clinical treatment.

Generally used examples of dental filling materials and dental treatment materials include gutta percha point, which is a type of rubber resin, silver point, paper point, and the like, which vary in use and composition.

Such dental filling material is typically formed to have a needle-like or cone-like shape, with a pointed distal tip and an opposite head gradually increasing in diameter.

FIG. 1 shows an example of a typical dental filling material.

As shown in FIG. 1, the dental filling material includes an insert, which is inserted into a root canal, a body having length mark thereon, and a colored portion on the head, which is painted with color ink.

In addition, dental filling materials having such a configuration are manufactured in a variety of sizes so that a dental filling material having the proper size can be selected according to the size (i.e., the diameter) of the dental root canal. Thus, the diameter of the distal tip of one dental filling material differs from that of another with a minute value of 0.05 mm.

Therefore, it is impossible to discern, with the naked eye, the sizes of dental filling materials that differ from each other by the minute values described above. Since the dental filling materials are manufactured and packed according to size, their sizes are marked on unit package containers or boxes, in which a certain number of dental filling materials are packed, and labels, on each of which a predetermined color code, such as red, blue, green, black, white, or yellow, is painted, are attached to respective unit package containers or boxes, so that users can more easily identify the sizes of specific dental filling materials that they intend to use.

However, this approach of identifying the sizes of the dental filling materials by the containers or boxes has the following problems. If dental filling materials that are slightly different in size from each other are mixed together when they are used, it is almost impossible to distinguish or re-sort the dental filling materials, and thus a dental filling material having the wrong size may be used. The filling of the root and the repair of a tooth, which requires the use of the dental filling material, are thus imperfectly conducted. This may entail the above-described damage in the clinical progress.

In order to solve the foregoing problems, dental filling materials were proposed (Korean Utility Model Application No. 1987-0001245). According to this approach, the dental filling materials have size-identifying colored portions formed directly on the heads thereof such that dental filling materials having different sizes can be easily distinguished from each other using the naked eye.

In addition, Korean Patent Application No. 1987-0002123 discloses an apparatus and method for marking the colored portion using ink and a tool.

However, since the colored portion cannot be marked without the coloring ink or the separate tool, this approach is difficult and entails low productivity, thereby resulting in a rise in manufacturing costs.

According to different approaches, dental filling materials can have a length mark formed on the body thereof, which typically indicates a work length. Such length marks were proposed, for example, in Korean Patent Application Nos. 1998-0044744 and 1998-0037719.

However, the conventional length-marking approaches are complicated and entail low productivity, thereby resulting in a rise in manufacturing costs.

As mentioned above, such a dental filling material having a needle-like or cone-like shape has a length mark on a body and a colored portion on a head, the color of the colored portion indicating the size (i.e., the diameter) of the dental filling material.

In addition, in the dental filling material having a needle-like or cone-like shape, the degree of taper thereof is not marked thereon, even though this is necessary. To date, it has been impossible to provide all marks (including a work length, a diameter, and a degree of taper).

### SUMMARY OF THE INVENTION

Various aspects of the present invention provide dental filling materials that are designed to have all of a work length, diameter (i.e., thickness), and the degree of taper marked on the bodies thereof in order to improve dental procedures, simplify manufacturing processing, and reduce manufacturing costs.

In an aspect of the invention, the dental filling material may include a head; a distal tip opposite the head, wherein the distal tip is designed to be first inserted into a tooth root canal; a body tapered from the head to the distal tip, with a diameter decreasing from the head to the distal tip; one or more work length marks formed on the body, wherein the work length marks indicate a work length; and one or more taper marks formed on the head in order to indicate a degree of taper. The work length marks may be formed on a portion of the body, the portion of the body extending to the distal tip with a predetermined interval from the taper marks. Both the taper marks and the work length marks may have the same color, which corresponds to a value of the diameter, in order to identify the diameter.

According to exemplary embodiments of the invention, it is possible to identify the dimensions of dental filling materials in dental procedures since all of the dimensions, namely, the size (i.e., the degree of taper and diameter) and the work length of the dental filling materials, can be marked on the bodies of the dental filling materials.

Accordingly, dental procedures are facilitated, additional marks on a container, which contains the dental filling materials, can be omitted, and the additional colored portion on the head can be omitted, thereby simplifying manufacturing processing and reducing manufacturing costs.

### BRIEF DESCRIPTION OF THE DRAWINGS

The above and other objects, features, and advantages of the present invention will be more apparent from the following detailed description in conjunction with the accompanying drawings, in which:

FIG. 1 is a perspective view schematically showing the configuration of a typical dental filling material;

FIG. 2 is perspective and front elevation views showing the configuration of a dental filling material according to an exemplary embodiment of the invention; and

FIGS. 3 to 22 are front elevation views showing the configurations of dental filling materials according to a variety of exemplary embodiments of the invention.

### DETAILED DESCRIPTION OF EXEMPLARY EMBODIMENTS

Exemplary embodiments of the present invention will now be described in detail with reference to the accompanying drawings. The same reference numbers are used throughout the drawings to refer to the same or like parts. Detailed descriptions of well-known functions and structures incorporated herein may be omitted in order to avoid obscuring the subject matter of the present invention.

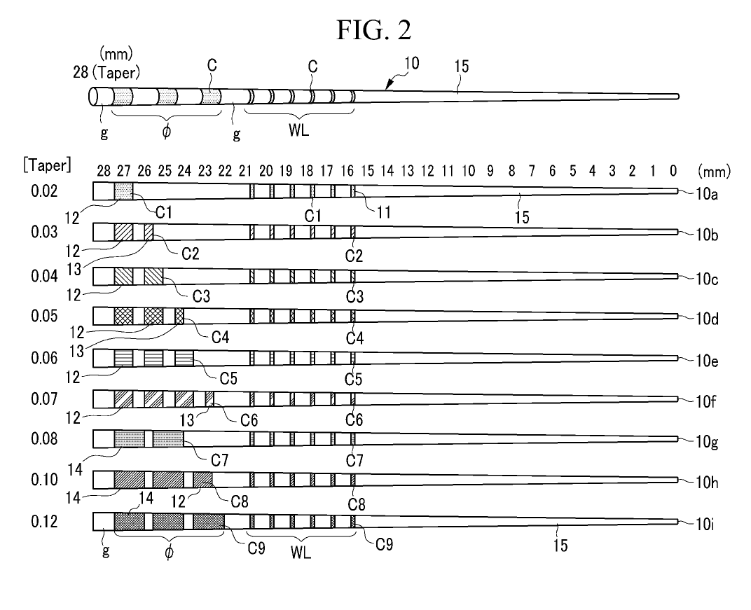

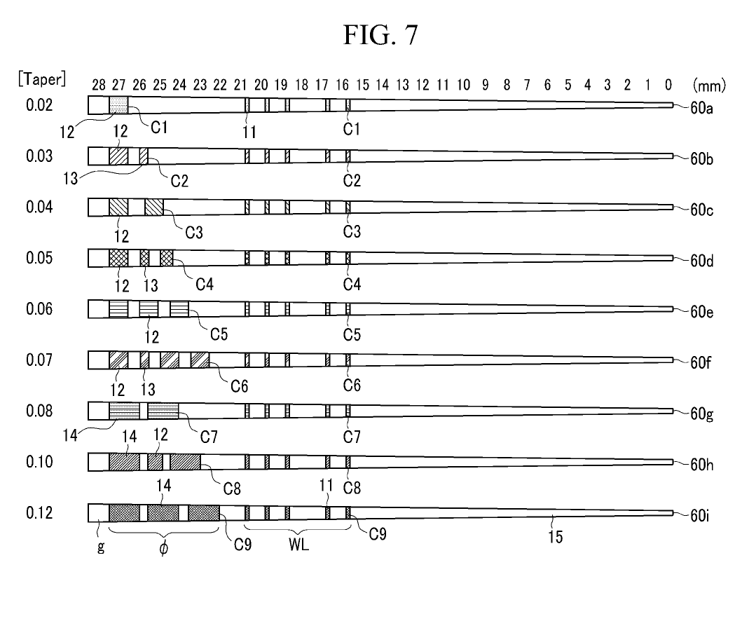

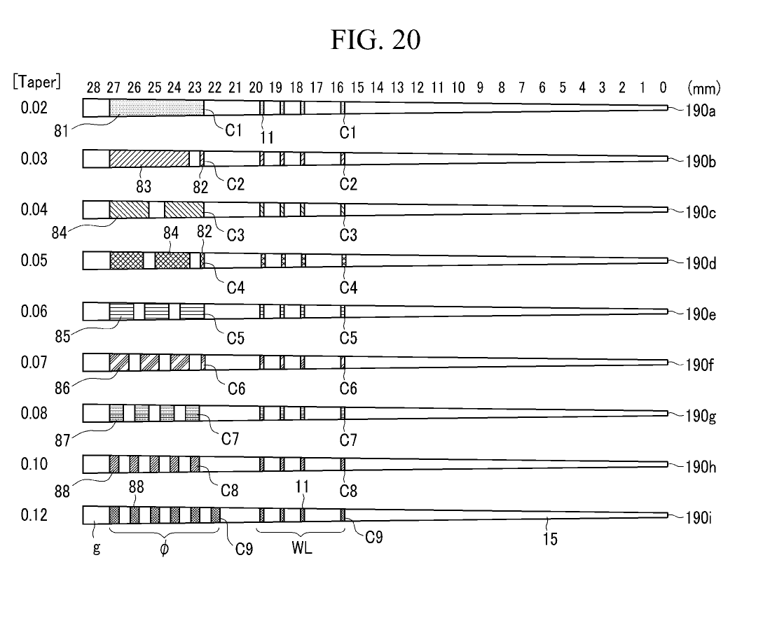

FIGS. 2 to 22 are views showing the configurations of dental filling materials according to a variety of exemplary embodiments of the invention.

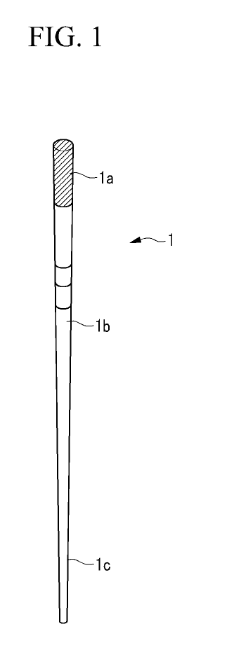

Below, a description will be given of the characteristic features of the dental filling materials according to exemplary embodiments of the invention. As for the configuration of general dental filling materials, FIG. 1 will be referred to.

First, as shown in FIG. 2 (A), a dental filling material 10 according to an exemplary embodiment of the invention is tapered from the head to the distal tip thereof. Specifically, the dental filling material 10 increases in diameter (or thickness) from the distal tip, which is designed to be first inserted into a tooth root canal, to the head opposite the distal tip. In addition, a work length is marked on a body 15 of the dental filling material 10 such that the dental filling material 10 can be inserted to the correct length into the tooth root canal.

Since the dental filling material 10 is configured as a needle-like or cone-like column, required are three (3) dimensions, namely: diameter, which indicates the size of the column, degree of taper, which indicates the degree of taper, and work length, which indicates the depth of insertion.

In order to satisfy these requirements, as shown in FIG. 2(A), the dental filling material 10 of this exemplary embodiment has colored portions C on the body 15. The colored portions C have the same color, and include taper marks Φ, which indicate the degree of taper, and work length marks WL, which indicate the work length.

For example, as shown in FIG. 2 (B) and FIGS. 3 to 22, colored portions C1 to C9 including the taper marks Φ and the work length marks WL are sequentially set to be black, green, blue, red, yellow, white, and the like according to the diameters. If greater diameters are necessary, the colored portions C1 to C9 are repeatedly marked.

In other words, the diameters are determined in the sequence of the colors of C1, C2, C3, C4, C5, C6, C7, C8, and C9. Since the diameters are generally determined according to standards in advance, the diameters of the dental filling materials can be identified by their colors, corresponding to any of C1, C2, C3, C4, C5, C6, C7, C8, and C9.

In addition, the taper marks Φ are formed on the heads in order to indicate the degrees of taper.

In greater detail, the degrees of taper are determined by the sizes of the taper marks Φ formed on the heads of the dental filling materials. The degrees of taper are divided into 0.01, 0.02, and 0.04 according to the sizes (or values) and/or numbers of the taper marks Φ.

Below, a description will be given of some exemplary embodiments with reference to the accompanying drawings.

As shown in FIGS. 2 to 11, if the degree of taper of a dental filling material 10a is 0.02, a first taper mark 12 having a predetermined width is formed (i.e., marked). If the degree of taper of a dental filling material 10b is 0.03, a first taper mark 12 and a second taper mark 13, which has a width half that of the first taper mark 12, are marked with an interval therebetween.

If the degree of taper of a dental filling material 10c is 0.04, two first taper marks 12 are marked with an interval therebetween.

In addition, if the degree of taper of a dental filling material 10d is 0.05, two first taper marks 12 and one second taper mark 13 are marked at regular intervals.

If the degree of taper of a dental filling material 10e is 0.06, three first taper marks 12 are marked at regular intervals. A dental filling material 10f having a degree of taper of 0.07 is marked in the same manner.

In a dental filling material 10g having a degree of taper of 0.08, a third taper mark 14, which has a width greater than that of the first taper mark 12, indicates a value of 0.04. Thus, two third taper marks 14 marked on the head of the dental filling material 10g indicate a degree of taper of 0.08.

If the degree of taper of a dental filling material 10h is 0.10, two third taper marks 14 and one first taper mark 12 are combined. If the degree of taper of a dental filling material 10i is 0.12, three third taper marks 14 are marked sequentially at regular intervals.

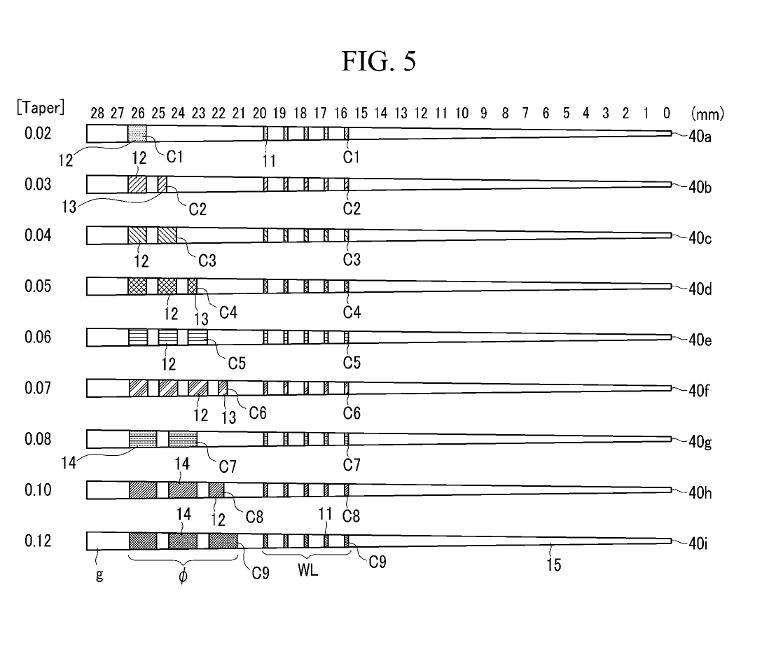

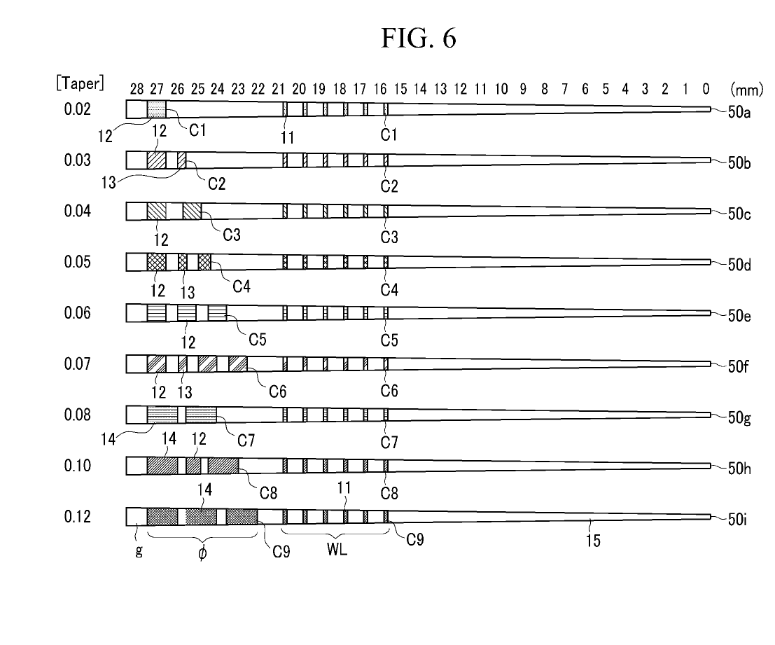

In particular, as shown in FIGS. 6 to 11, the sequences of second and third taper marks 13 and 14 can be exchanged. That is, even if the sequences of the second and third taper marks 13 and 14 are exchanged, unlike those shown in FIG. 5, the taper marks can be regarded as indicating the same degree of taper.

In addition, a description will be given of some exemplary embodiments in which taper marks Φ are used in different patterns to indicate sizes.

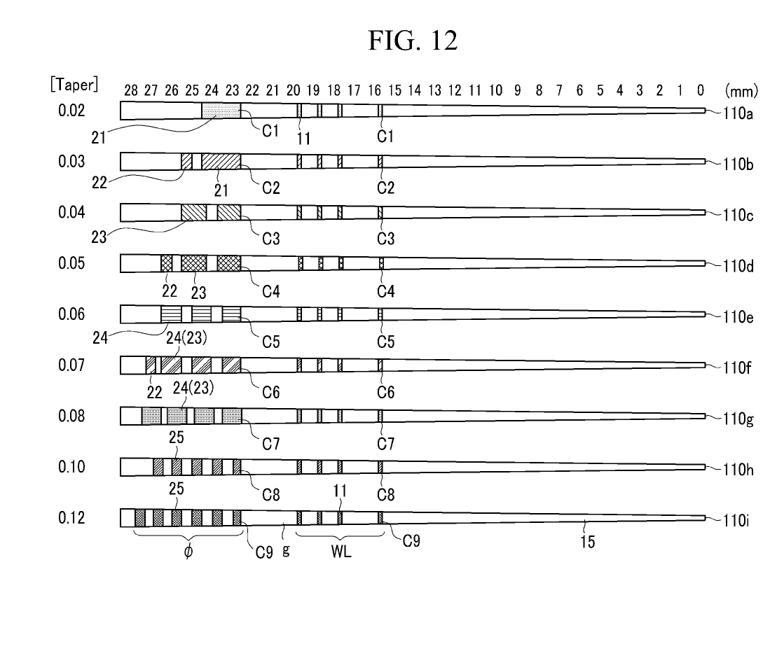

An exemplary embodiment shown in FIG. 12 uses substantially the same marking pattern as described above. In a dental filling material 110a shown in FIG. 12, a fourth taper mark 21 having an intended width is marked on the head, with an interval g from the end of the head. This indicates the minimum degree of taper of 0.02.

If the degree of taper of a dental filling material 110b is 0.03, a fifth taper mark 22, which has a width smaller than that of the fourth taper mark 21, is formed on the head at an interval from the fourth taper mark 21. The fifth taper mark 22 indicates a value of 0.01. Accordingly, the fourth taper mark 21 and the fifth taper mark 22 indicate that the degree of taper of the dental filling material 110b is 0.03.

If the degree of taper of a dental filling material 110c is 0.04, two sixth taper marks 23, which have a width intermediate between that of the fourth taper mark 21 and that of the fifth taper mark 22, are formed with an interval therebetween on the head. This indicates that the degree of taper of the dental filling material 110c is 0.04.

If the degree of taper of a dental filling material 110d is 0.05, three taper marks, including two sixth taper marks 23 and one fifth taper mark 22, are formed at regular intervals on the head. This indicates that the degree of taper of the dental filling material 110d is 0.05.

If the degree of taper of a dental filling material 110e is 0.06, three seventh taper marks 24, which have a width smaller than that of the sixth taper mark 23, are formed sequentially at regular intervals on the head. This indicates that the degree of taper of the dental filling material 110e is 0.06.

If the degree of taper of a dental filling material 110f is 0.07, three seventh taper marks 24 and one fifth taper mark 22 are formed at regular intervals on the head. This indicates that the degree of taper of the dental filling material 110f is 0.07.

If the degree of taper of a dental filling material 110g is 0.08, four seventh taper marks 24 are formed at regular intervals.

In the case of a dental filling material 110h having a degree of taper of 0.10 and a dental filling material 110i having a degree of taper of 0.12, eighth taper marks 25 and ninth taper marks 26, which are somewhat narrower than the eighth taper marks 25, are combined. That is, one eighth taper mark 25 indicates a value of 0.02, and one ninth taper mark 26 indicates a value of 0.01.

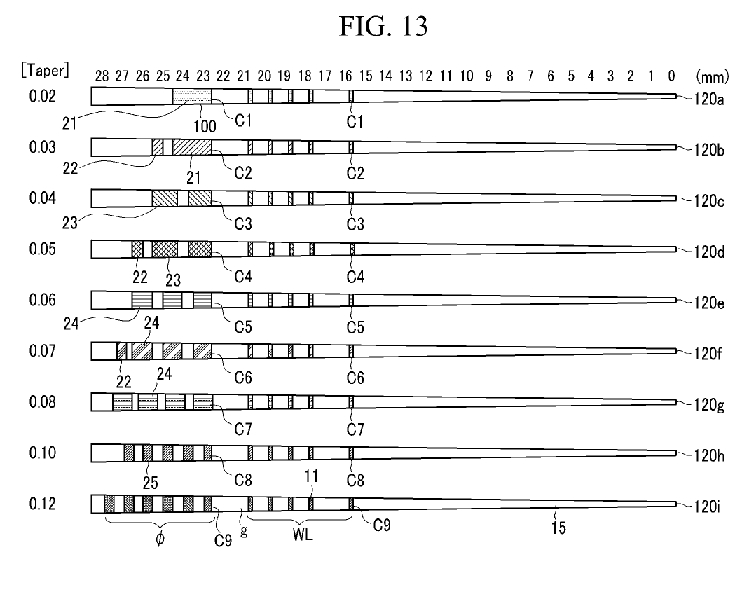

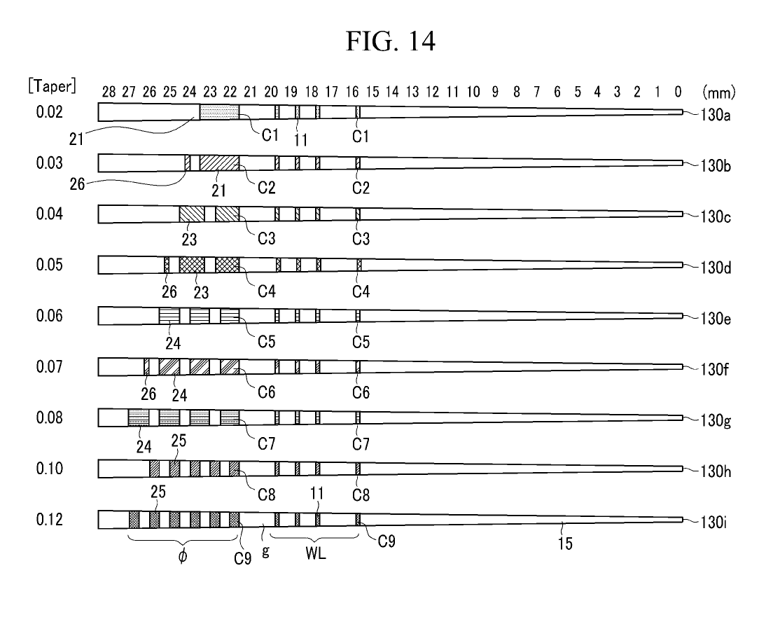

The same marking patterns are applied to dental filling materials 120a to 120i shown in FIG. 13 and dental filling materials 130a to 130i shown in FIG. 14.

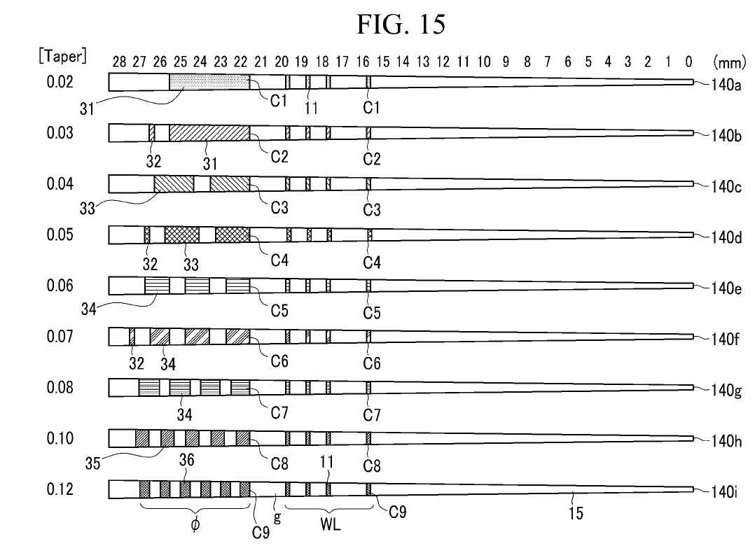

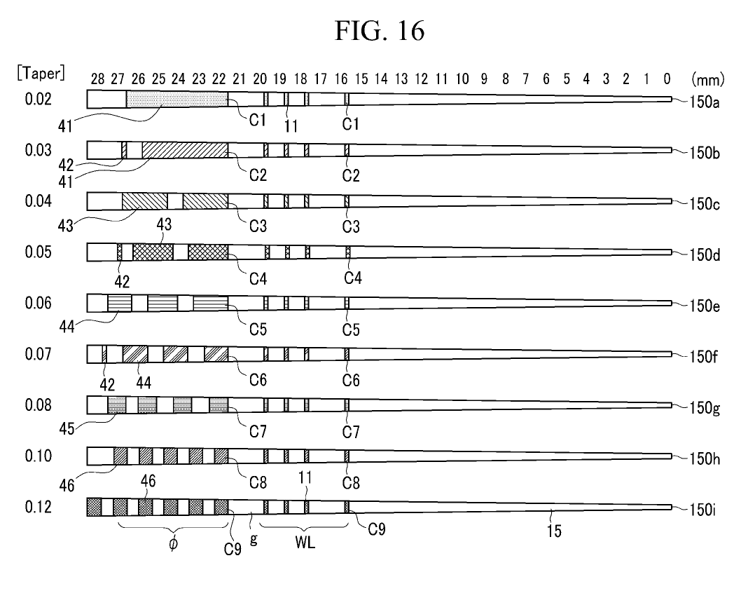

Likewise, in the case of dental filling materials shown in FIGS. 15 and 16, taper marks, which have relatively greater differences in sizes, are used to indicate degrees of taper. As shown in the figures, the size of a mark 31 on a first dental filling material 140a, which indicates a value of 0.02, is significantly different from that of a taper mark 32 on a second dental filling material 140b, which indicates a value of 0.03.

In third and subsequent dental filling materials 140c to 140i, the degrees of taper gradually increase, in the sizes of taper marks 33, 34, 35, and 36, which indicate a value of 0.02, of the third or later dental filling materials 140c to 140i gradually decrease. These marking patterns are the same as described above and are applied in the same manner to dental filling materials 150a to 150i, shown in FIG. 16.

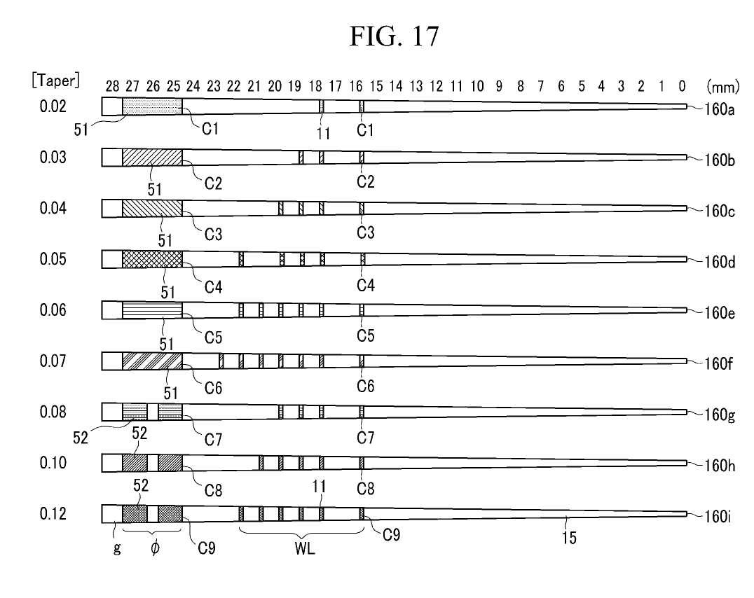

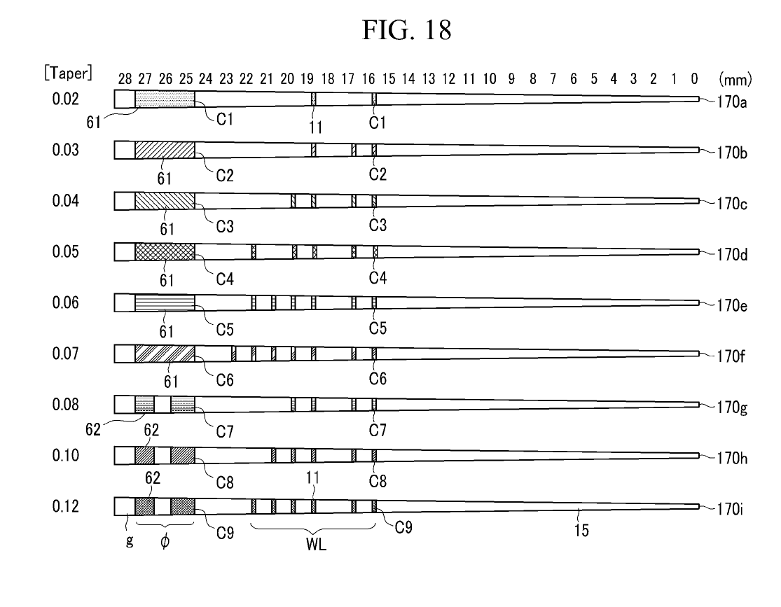

In addition to the above-described marking patterns, as shown in FIGS. 17 and 18, the degrees of taper of dental filling materials 160a to 170i are distinguished by values, obtained by multiplying the number of taper marks Φ formed on the heads of the dental filling materials 160a to 170i with the number of work length marks WL 11.

These values can be expressed by Formula 1 below:

Degree of taper=the number of taper marks Φ×the number of work length marks WL Formula 1

Here, the value of one taper mark Φ is 0.01.

In particular, in FIGS. 17 and 18, the degree of taper is obtained by setting the value of one taper mark Φ as 0.01 regardless of the sizes of taper marks Φ 51, 52, 61, and 62 and multiplying the value of one taper mark with the number of the work length marks WL 11. As an example, in the case of the first dental filling material 160a in FIG. 17, the degree of paper is 0.02=0.01×2. Thus, the dental filling material 160a has a degree of taper of 0.02.

As another example, the last dental filling material 170i in FIG. 18 includes two taper marks Φ 62 and two work length marks WL 11. Thus, the degree of taper of the dental filling material 170i is 0.12=0.02×6.

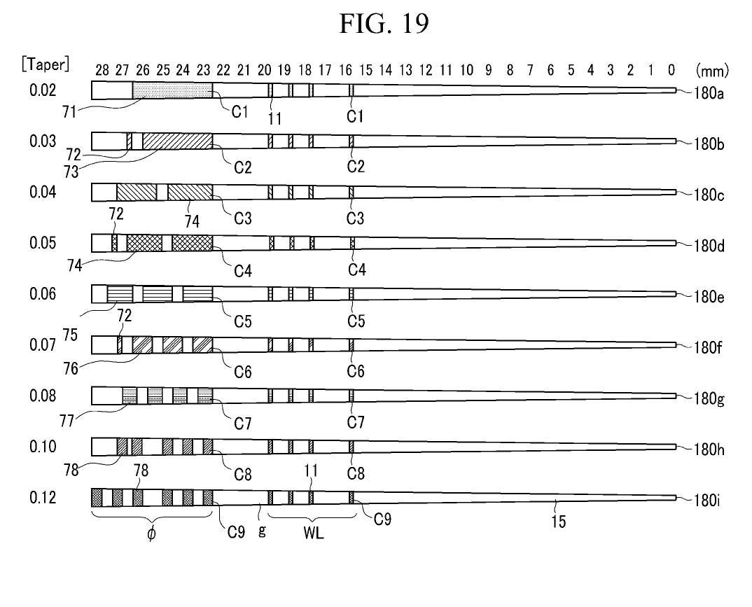

FIGS. 19 to 21 also show the same marking patterns as that in FIG. 16 described above. Specifically, respective taper marks Φ 71 to 88 are set to indicate a value of 0.01 or 0.02, and their numbers are counted. If there are two or more taper marks having the same size, each taper mark is calculated to have a value of 0.02. If taper marks having different sizes are mixed together, a larger one is calculated to have a value of 0.02 and a smaller one is calculated to have a value of 0.01.

In addition, as shown in FIGS. 2 to 21, the work length marks WL 11 are formed on a portion of the body, which extends toward the distal tip, with an interval from the taper marks Φ. The work length marks WL 11 can be marked on the body in the range from 16 mm to 27 mm from the distal tip, with intervals such as 1 mm, 2 mm, 3 mm, and 4 mm.

In this disclosure, dental filling materials having a length of 28 mm will be described by way of an example.

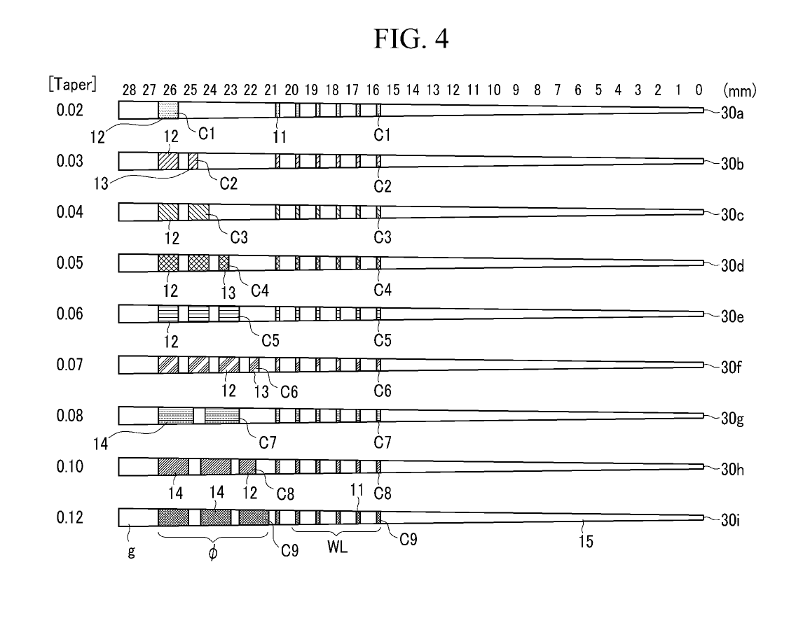

In the cases of the dental filling materials 10a to 10i shown in FIG. 2, the dental filling materials 30a to 30i shown in FIG. 4, and the dental filling materials 50a to 50i, six (6) work length marks WL 11 are marked on the body in the range from 16 mm to 21 mm from the distal tip, with an interval of 1 mm.

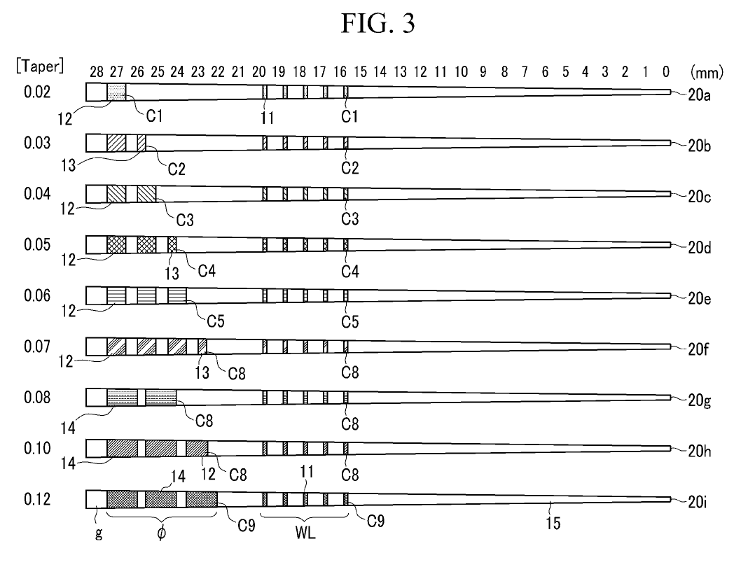

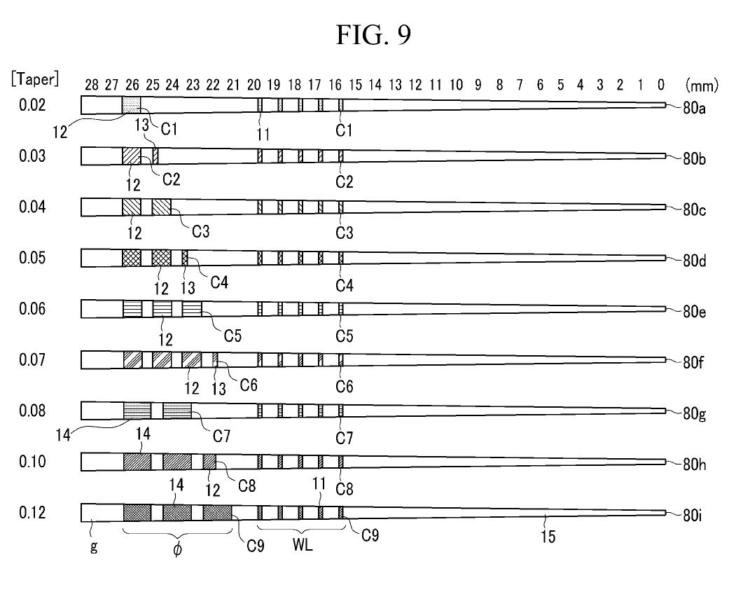

In the cases of the dental filling materials 20a to 20i shown in FIG. 3, the dental filling materials 40a to 40i shown in FIG. 5, and the dental filling materials 80a to 80i shown in FIG. 9, five (5) work length marks WL 11 are marked on the body in the range from 16 mm to 21 mm from the distal tip, with an interval of 1 mm.

In addition, in the case of the dental filling materials 60a to 60i, five (5) work length marks WL 11 are marked at positions 16 mm, 17 mm, 19 mm, 20 mm, and 21 mm from the distal tip.

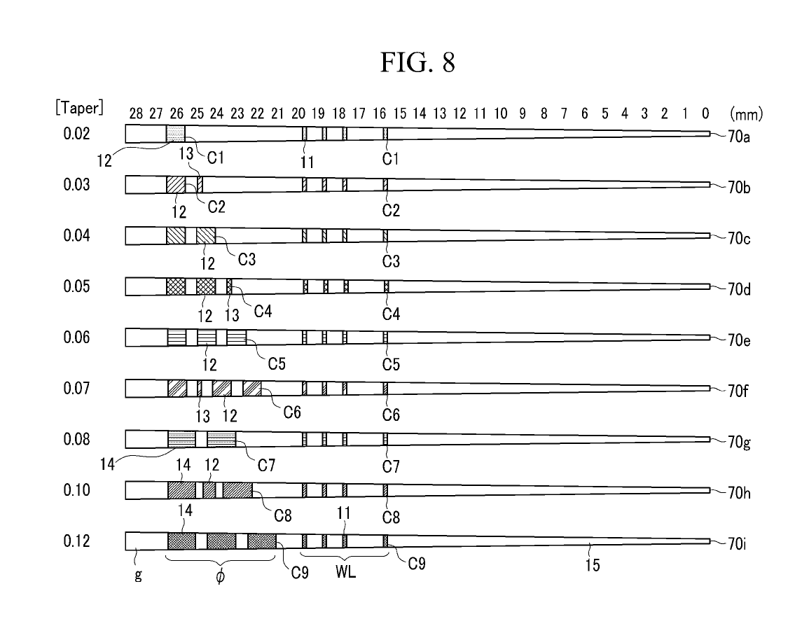

In the cases of the dental filling materials 70a to 70i shown in FIG. 8, the dental filling materials 110a to 110i shown in FIG. 12, and the dental filling materials 130a to 130i, 140a to 140i, and 150a to 150i shown in FIGS. 14 to 16, four (4) work length marks WL 11 are marked at positions 16 mm, 18 mm, 19 mm, and 20 mm from the distal tip.

In the case of the dental filling materials 80a to 80i shown in FIG. 9, five (5) work length marks WL 11 are marked at positions 16 mm, 17 mm, 18 mm, 19 mm, and 20 mm from the distal tip.

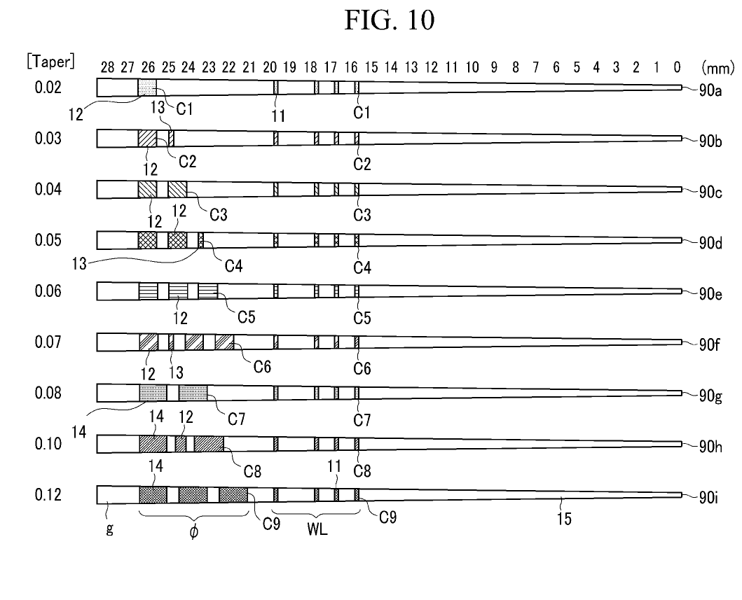

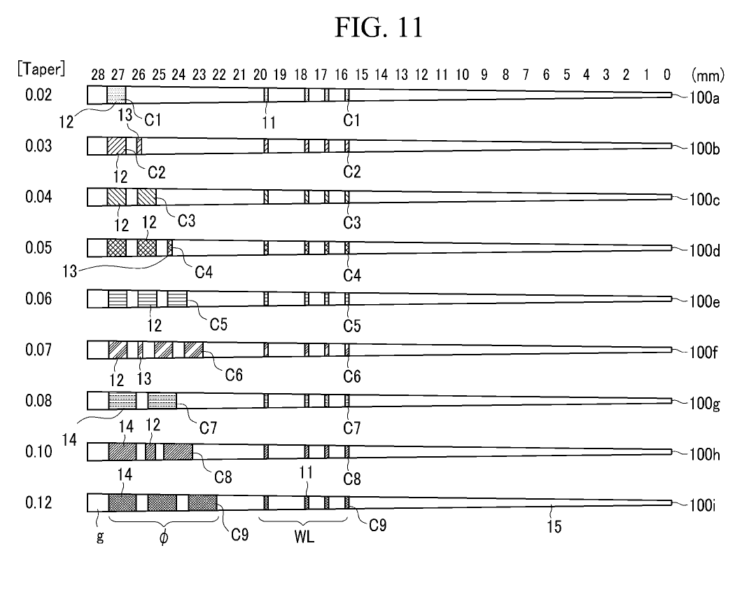

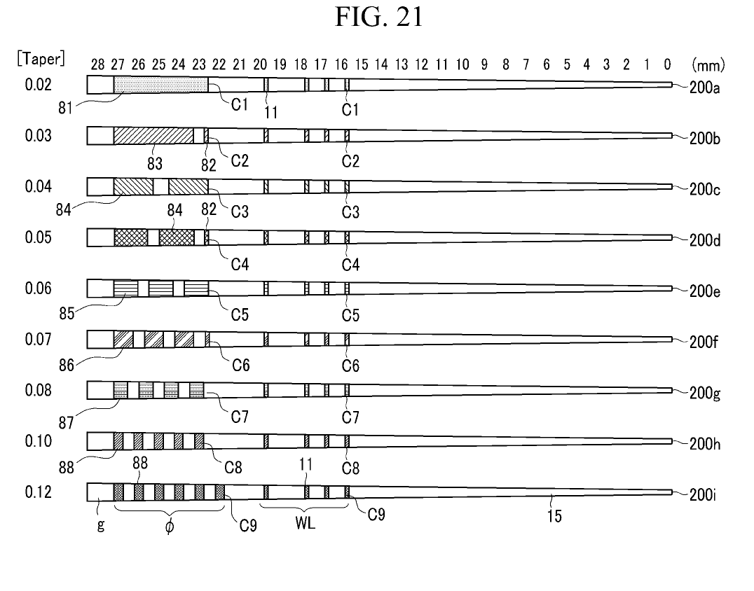

In the cases of the dental filling materials 90a to 90i shown in FIG. 10, the dental filling materials 100a to 100i shown in FIG. 11, and the dental filling materials 200a to 200i shown in FIG. 21, four (4) work length marks WL 11 are marked at positions 16 mm, 17 mm, 18 mm, and 20 mm from the distal tip.

In the case of the dental filling materials 120a to 120i shown in FIG. 13, five (5) work length marks WL 11 are marked at positions 16 mm, 18 mm, 19 mm, 20 mm, and 21 mm from the distal tip.

Referring to FIG. 17, in the case of the dental filling material 160a, two (2) work length marks WL 11 are marked at positions 16 mm and 18 mm from the distal tip, and in the case of the dental filling material 160b, three (3) work length marks WL 11 are marked at positions 16 mm, 18 mm, and 19 mm from the distal tip.

In the case of the dental filling materials 160c and 160g, four (4) work length marks WL 11 are marked at positions 16 mm, 18 mm, 19 mm, and 20 mm from the distal tip, and in the case of the dental filling material 160d, five (5) work length marks WL 11 are marked at positions 16 mm, 18 mm, 19 mm, 20 mm, and 22 mm from the distal tip.

In the case of the dental filling materials 160e and 160i, six (6) work length marks WL 11 are marked at positions 16 mm, 18 mm, 19 mm, 20 mm, 21 mm, and 22 mm from the distal tip, and in the case of the dental filling material 160f, seven (7) work length marks WL 11 are marked at positions 16 mm, 18 mm, 19 mm, 20 mm, 21 mm, 22 mm, and 23 mm from the distal tip.

Also, in the case of the dental filling material 160h, five (5) work length marks WL 11 are marked at positions 16 mm, 18 mm, 19 mm, 20 mm, and 21 mm from the distal tip.

Referring to FIG. 18, in the case of the dental filling material 170a, two (2) work length marks WL 11 are marked at positions 16 mm and 19 mm from the distal tip, and in the case of the dental filling material 170b, three (3) work length marks WL 11 are marked at positions 16 mm, 17 mm, and 19 mm from the distal tip.

In the case of the dental filling materials 170c and 170g, four (4) work length marks WL 11 are marked at positions 16 mm, 17 mm, 19 mm, and 20 mm from the distal tip, and in the case of the dental filling material 170d, five (5) work length marks WL 11 are marked at positions 16 mm, 17 mm, 19 mm, 20 mm, and 22 mm from the distal tip.

In the case of the dental filling materials 170e and 170i, six (6) work length marks WL 11 are marked at positions 16 mm, 17 mm, 19 mm, 20 mm, 21 mm, and 22 mm from the distal tip, and in the case of the dental filling material 170f, seven (7) work length marks WL 11 are marked at positions 16 mm, 17 mm, 19 mm, 20 mm, 21 mm, 22 mm, and 23 mm from the distal tip.

Also, in the case of the dental filling material 170h, five (5) work length marks WL 11 are marked at positions 16 mm, 17 mm, 19 mm, 20 mm, and 21 mm from the distal tip.

In addition, in the cases shown in FIGS. 2 to 11, 17, 18, 20, and 21, the taper marks Φ are marked based on the interval g from the outermost position of the head of the dental filling material, and in the cases shown in FIGS. 12 to 16 and 19, the taper marks Φ are marked based on the interval g from the work length marks WL 11.

In the above, the width of the interval g is determined depending on the marking patterns of the taper marks Φ, which indicate the degrees of taper, in the former cases, and depending on the marking patterns of the work length marks WL 11 in the later cases.

Below, a description will be given of the dental filling materials according to exemplary embodiments of the invention that have the above-described configurations.

Above all, a description will be given of only the characteristic features of the invention. As for the operation of general dental filling materials, FIG. 1 will be referred to.

Returning to the figures, as described above, the dental filling materials require three (3) dimensions, namely: diameter, degree of taper, and work length.

Therefore, the dental filling materials 10a to 200i according to exemplary embodiments of the invention have all of the above-described marks formed thereon. First, the diameters are divided according to the colors C1 to C9 of the taper marks Φ and the work length marks WL, which are formed on the bodies 15. For example, colors, such as black, green, blue, red, yellow, white, and the like, are set sequentially according to the sizes of the diameters. If a greater diameter is necessary, the sequences of the colors are repeated. Therefore, it is possible to easily recognize the diameters of the dental filling materials 10a to 200i by applying standard sizes to the colors of the taper marks Φ and the work length marks WL.

In this disclosure, the colors C1 to C9 are illustrated by way of an example, but the number of colors can be added depending on the number of the standard sizes. For example, the colors can be expanded to embrace other colors, such as C1p, C11, and the like, which are not illustrated in the figures.

In the conventional dental filling materials, the bodies have a specific color (e.g., pink or light pink) and specific colors, which indicate respective diameters, are painted on the heads. Thus, the manufacturing processing is complicated, thereby increasing manufacturing costs.

To overcome such problems, in exemplary embodiments of the invention, all of the bodies have respective colors, which indicate respective diameters. This, however, does not cause additional costs. When the taper marks Φ are formed on the heads of the dental filling materials 10a to 200i, so that each taper mark Φ indicates a value of 0.01, 0.02, or 0.04, the degrees of taper of the dental filling materials 10a to 200i can be easily obtained by multiplying the values (0.01, 0.02, and 0.04) of the taper marks Φ with the number of the taper marks Φ.

The degree of taper can be obtained in a different method. As shown in FIGS. 17 and 18, the degree of taper can be easily calculated by multiplying the number of the taper marks Φ with the number of the work length marks WL 11. Here, the value of one taper mark Φ is 0.01.

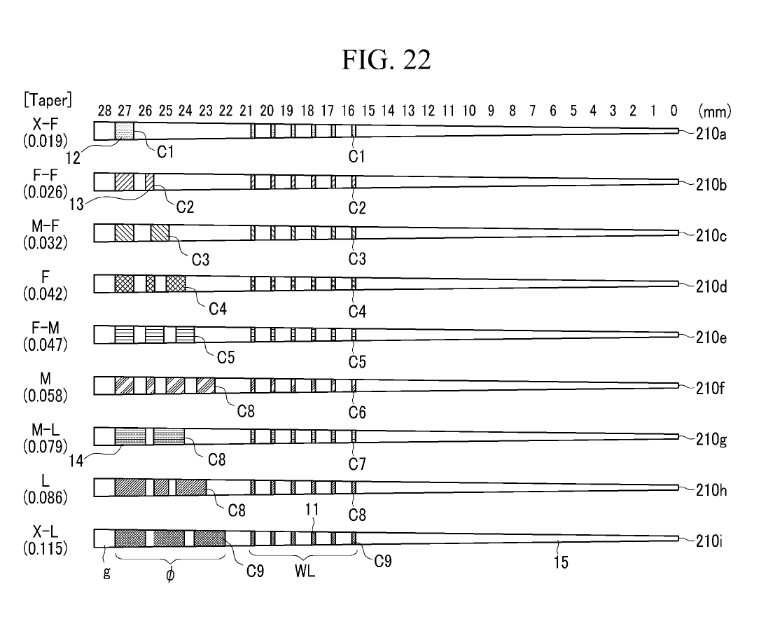

In some cases, the degrees of taper differ from those in FIGS. 2 to 21. As shown in FIG. 22, the degrees of taper of dental filling materials 210a to 210i can be obtained by applying the sizes and number of the taper marks Φ of the dental filling materials 210a to 210i to degrees of taper of preset standards X-F to X-L.

In other words, the degrees of taper can be easily obtained by applying the degrees of taper of the preset standards X-F to X-L sequentially according to the sizes and number of the taper marks Φ.

Since the degrees of taper of the dental filling materials 10a to 210i can be easily obtained from the taper marks Φ formed on the heads of the dental filling materials 10a to 210i, it is possible to easily carry out dental procedures.

In addition, the work length marks WL 11 are narrow stripes (or lines) formed on intermediate portions of the bodies. The work length marks WL 11 have intended lengths in the generally-used range from 16 mm to 24 mm from the distal tip.

As described above, according to exemplary embodiments of the invention, all of the dimensions, which indicate the sizes and work lengths of the dental filling materials, can be marked on the dental filling materials.

While the present invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A dental filling material comprising:
a head;
a distal tip opposite the head, wherein the distal tip is designed to be first inserted into a tooth root canal;
a body tapered from the head to the distal tip, with a diameter decreasing from the head to the distal tip;
one or more work length marks formed on the body, wherein the work length marks indicate a work length; and
one or more taper marks formed on the head in order to indicate a degree of taper,
wherein the work length marks are formed on a portion of the body, the portion of the body extending to the distal tip with a predetermined interval from the taper marks, and
wherein both the taper marks and the work length marks have equal color, which corresponds to a value of the diameter, in order to identify the diameter.

2. The dental filling material according to claim 1, wherein the work length marks are formed on the body, in a range from 16 mm to 27 mm from the distal tip, with an interval of 1 mm, 2 mm, 3 mm, or 4 mm.

3. The dental filling material according to claim 1, wherein the taper marks are formed with a predetermined interval from an outermost position of the head.

4. The dental filling material according to claim 1, wherein the taper mark is formed with a predetermined interval from the work length mark.

5. The dental filling material according to claim 1, wherein the degree of taper is determined according to@ widths and numbers of the taper marks formed on the head.

6. The dental filling material according to claim 5, wherein, if one taper mark is formed, the taper mark indicates a value of 0.02, and if two or more taper marks having an equal size are formed, the taper marks indicate a value of 0.02 or 0.04.

7. The dental filling material according to claim 5, wherein, if two or more taper marks having different sizes are formed, a larger one of the taper marks indicates a value of 0.02 or 0.04, and a smaller one of the taper marks indicates a value of 0.01.

8. The dental filling material according to claim 5, wherein the taper marks are divided by values, obtained by multiplying the number of the taper marks formed on the head and the number of the work length marks, wherein one of the taper marks indicates a value of 0.01.

9. The dental filling material according to claim 5, wherein a standard degree of taper, which is determined according to the values and numbers of the taper marks, is applied.
